(19) United States
(12) Patent Application Publication
(10) Pub. No.: US 2002/0065746 A1
(43) Pub. Date: May 30, 2002

(54) System and method of advertising on a computer network

(76) Inventor: Adrianne Lewis, Langhorne, PA (US)

Correspondence Address: SCHNADER HARRISON SEGAL & LEWIS, LLP, 1600 MARKET STREET, SUITE 3600, PHILADELPHIA, PA, 19103

(21) Appl. No.: 09/981,156

(22) Filed: Oct. 17, 2001

Related U.S. Application Data
(60) Provisional application No. 60/241,918, filed on Oct. 20, 2000.

(51) Int. Cl. G06F 17/60

(52) U.S. Cl. 705/27

(57) ABSTRACT

A method of advertising and an advertising game are disclosed wherein advertising images and promotional information are incorporated into an interactive game. Players are presented the game via a computer network and are prompted to access advertising material associated with the advertising images to play the game. Also disclosed are a method in a computer system for accommodating advertising content, a computer data signal embodied in a transmission medium to execute an advertising game on a computer network and a template for an interactive game.

### CROSS REFERENCE TO RELATED COPENDING APPLICATION

This application is based on and claims priority to the provisional application having a serial No. 60/241,918 and filed on Oct. 20, 2000.

### COPYRIGHT NOTICE AND AUTHORIZATION

Portions of the documentation in this patent document contain material that is subject to copyright protection. The copyright owner has no objection to the photocopying by anyone of the patent document or the patent disclosure as it appears in the Patent and Trademark Office file or records, but otherwise reserves all copyright rights whatsoever.

### FIELD OF THE INVENTION

The present invention relates to an advertising game suitable for play on a computer network.

### BACKGROUND OF THE INVENTION

Advertising over computer networks such as the Internet, has dramatically increased in recent years. Internet advertising allows companies to interact with consumers and receive feedback from, and information about such individuals.

Internet advertising includes banner advertisements and pop-up windows. These types of advertisements appear automatically on a user's screen. The user has no control over whether they want to view these ads. Consequently, users often find these ads annoying and disruptive.

Advertisers have attempted to incorporate their logos into games to promote their products and services in a format welcomed by consumers. This type of advertising is devoid of descriptive material, such as product and company information.

Advertisers have employed mechanisms within games to prompt users to access their websites to expose consumers to promotional material. This slows the pace of games, lessening the game's appeal, and potentially causing consumers to lose interest in play.

### DESCRIPTION OF THE DRAWINGS

The invention is best understood from the following detailed description when read with the accompanying drawings.

FIG. 1 is a screen shot of a trivia game according to an illustrative embodiment of the invention.

FIG. 2 is a site information page according to an illustrative embodiment of the invention.

FIG. 3 is a logon screen according to an illustrative embodiment of the invention.

FIGS. 4A-C are illustrative screens depicting trivia game questions and answers.

FIG. 5 is an illustrative screen depicting a game clue.

FIG. 6 is a “game over” page according to an illustrative embodiment of the invention.

FIGS. 7A-E depict screen shots of games according to illustrative embodiments of the invention.

### SUMMARY OF THE INVENTION

Embodiments of the present invention include a method of advertising and an advertising game wherein advertising images and promotional information are incorporated into an interactive game. In an illustrative embodiment of the invention, one or more advertising images are incorporated into the interactive game, for example as game pieces. One or more players are presented the game via a computer network. Players are prompted to access advertising material associated with the advertising images to play the game. Advantageously, the advertising material is accessible independent of accessing an advertiser's website. Games may include for example, trivia games, bingo, dominoes, casino games, card games, tic-tac-toe and jigsaw puzzles.

Embodiments of the present invention further include a method in a computer system for accommodating advertising content and a computer data signal embodied in a transmission medium to execute an advertising game on a computer network.

Still further, embodiments of the invention include a template for an interactive game that can be re-used to incorporate different advertising images and material.

### DETAILED DESCRIPTION OF THE INVENTION

Embodiments of the present invention provide effective advertising tools with potential benefits to both advertisers and consumers.

The present invention integrates advertising into a game format. The game format attracts consumers repeatedly, enabling advertisers to disseminate promotional information to a captive audience, likely on a repetitive basis.

Advertising images are incorporated into an interactive game, for example as game pieces, indicia or other game elements. Preferably, the advertising images are active game elements, meaning that a player's attention must be directed specifically to the advertising, image and the player must actively use it, such as by clicking on the image to select an answer or make a move. The images may be, for example, trademarks, logos, products, brand names or company names. Any interactive game in which such images may be incorporated is within the scope of the invention. Illustrative examples of game types include trivia games, bingo, dominoes, casino games, such as slot machines, card games, tic-tac-toe and jigsaw puzzles. The images alone provide advertisement. The games, however, may go beyond merely presenting advertising images by adding additional advertising material associated with the images.

The interactive game is presented to one or more players, preferably via a computer network, such as, for example, the Internet. In an exemplary embodiment, the interactive game can be presented to a player via any commercially available personal computer or similar device having, for example, a processor, such as a Pentium® 4, memory, a screen display and keyboard. The terms “computer”, “computer network” or “network” as used herein should be broadly construed to include any device capable of receiving, transmitting and/or using information, including, without limitation, a processor, microprocessor or similar device, a personal computer such as a laptop, palm, PC, desktop or workstation, a network server, a mainframe, and an electronic wired or wireless device. Further, a computer, computer network, or network of the invention may operate in communication with other systems over any type of network, such as, for example, the Internet, an intranet, or an extranet, or may operate as a standalone system.

The players are prompted to access additional advertising material to progress in the game. The additional material may be incorporated directly into the game, providing players with promotional material instantly. This is a significant improvement over advertising methods that require a player to access an advertiser's website. The time required to open an additional website and scan it for information needed may be a frustration to players. By providing promotional material instantly, for example, by a pop-up window, the game progresses at a faster pace than if the player was required to access an advertiser's website.

In an exemplary embodiment of the invention, the interactive game is a trivia game based on the consumer's knowledge of the advertised company, products, services and/or brands. Advertising images are displayed to the player and questions are asked related to the advertised subject matter. Players are provided with clues that contain promotional material, such as description of products, company information and educational material.

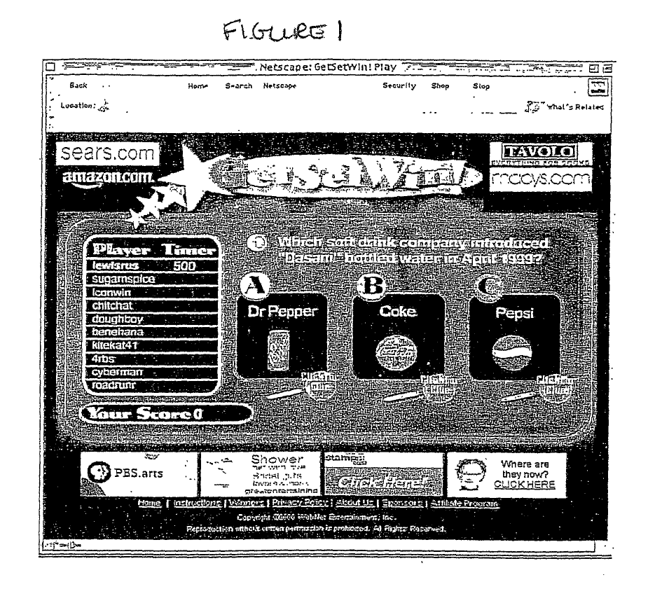

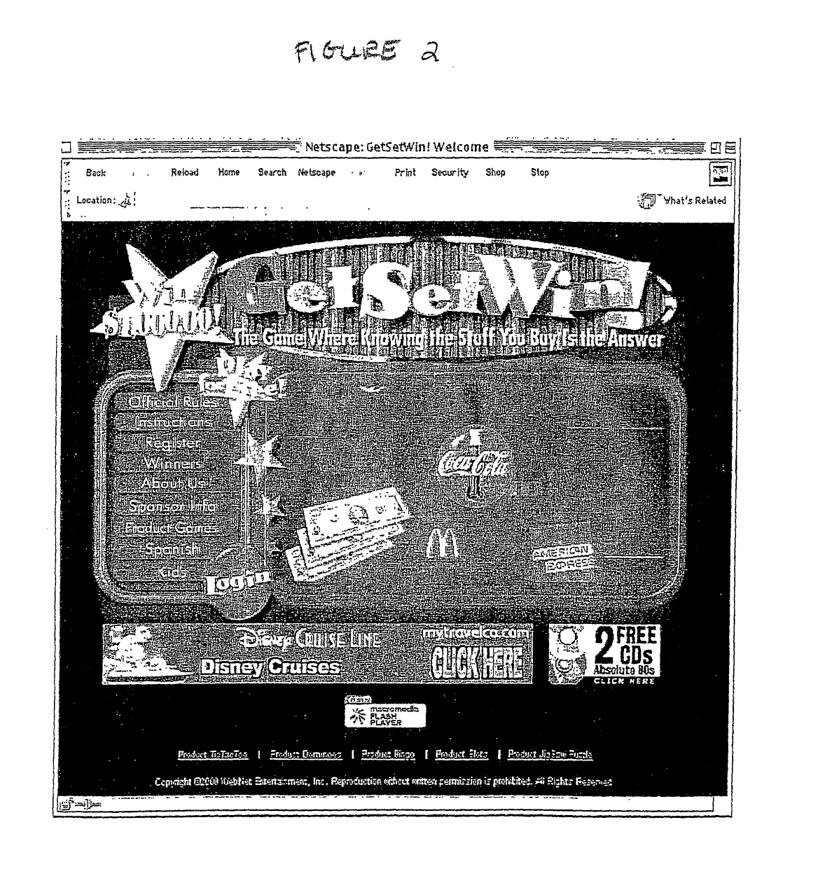

FIG. 1 is a screen shot of a trivia game according to an illustrative embodiment of the invention. The screen provides a trivia question related to three brands of soft drinks. A player may click on a “Click-For-ClueTM” icon to obtain information to assist the player in answering the trivia question. Preferably these clues include promotional material from the advertiser. The additional promotional material is immediately accessible as compared to requiring a player to access an advertiser's website.

The immediate access of additional advertising material is particularly beneficial because it can be designed to target the specific player. For example, a player may be required to answer preliminary questions prior to starting the game which would enable the system to categorize the player and provide advertising material directed to the player. Illustrative player criteria may include age, gender and residence. If an advertiser desires, it may, in addition to inserting instant promotional material, provide links to websites.

Prizes may be offered in connection with the interactive game to attract players. A point system may also be used wherein a player may accumulate points by continuing or repeatedly playing games to promote prolonged exposure of the player to advertising images and material.

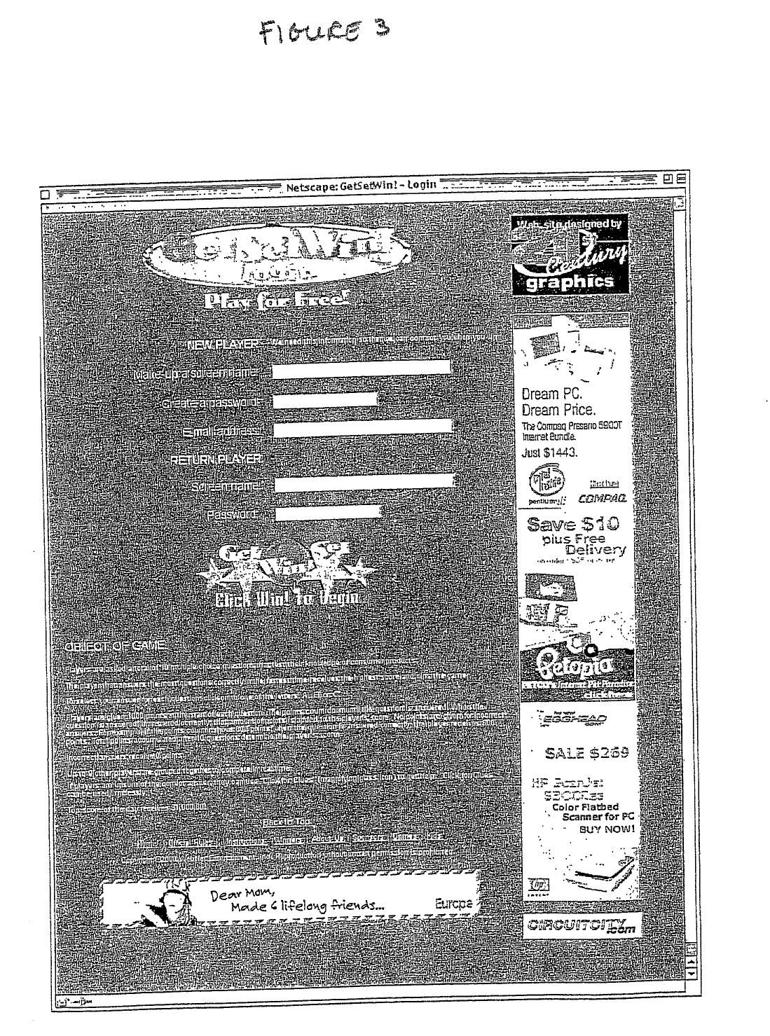

FIGS. 1-6 provide illustrative embodiments of the invention. Players access the game on a computer network and are presented with a page featuring various site information, as illustrated in FIG. 2. Additional pages accessible from the home page may include, for example, official rules, instructions, registration, list of winners, advertiser information, games, alternative languages, and pages directed to children.

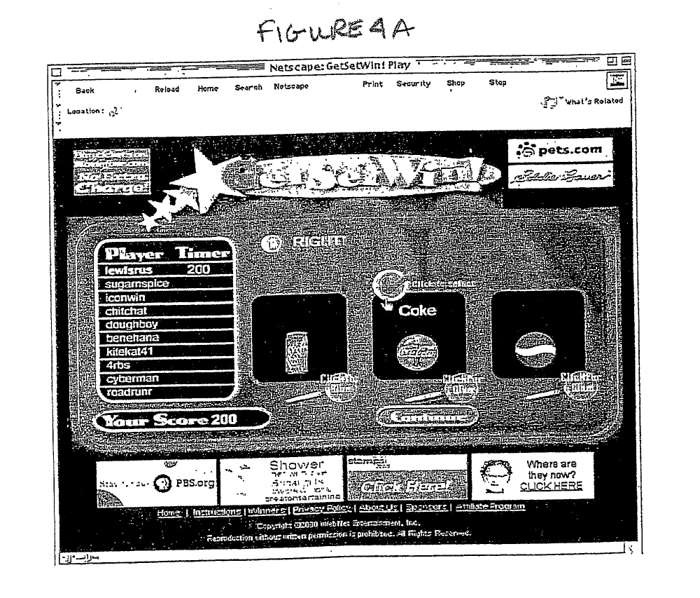

Players may log on via a logon screen as depicted in FIG. 3. The illustrative logon page depicted in FIG. 3 includes game instructions. Games may be played as individuals or as a group. Preferably, players are grouped according to background information provided at the time of log in. In an exemplary embodiment a page displays a count down during which time other players may be grouped together, thereby increasing the element of competition.

In a further embodiment, players are asked a defined number of multiple-choice questions, such as ten in this embodiment, testing their knowledge of consumer products. Advertising images, such as company logos and product icons are graphically displayed within the multiple-choice selections. The player who answers the most questions correctly in the fastest time receives the highest score and wins the game.

Games may be offered free of charge or for a fee. Players may be provided an opportunity to win cash and/or prizes, giving them incentive to play the games and revisit the site. The following is a prize structure according to an illustrative embodiment of the invention. Players with the highest daily score may be awarded cash or prizes. Additionally, the highest weekly, monthly and yearly scores may be tracked and prizes awarded accordingly. In another illustrative embodiment, top contestants for each day, month, and/or year may be awarded points that can be accumulated to redeem merchandise.

A point system may be provided as illustrated by the following example. Players are given points at the start of each question. The number of points is continually reduced until the question is answered. When the question is answered, if answered correctly, the amount of points existing at that time is added to the player's score. Incorrect answers receive no points. Total points accumulated after a predetermined number of questions determines the final score.

When players need help answering a question, they can activate the “Click-For-Clues TM™” function as found on the magnifying glass shown in FIG. 1. A screen pops up containing marketing information about the advertised subject matter in question. The information may be in the form of text, graphics and/or audio.

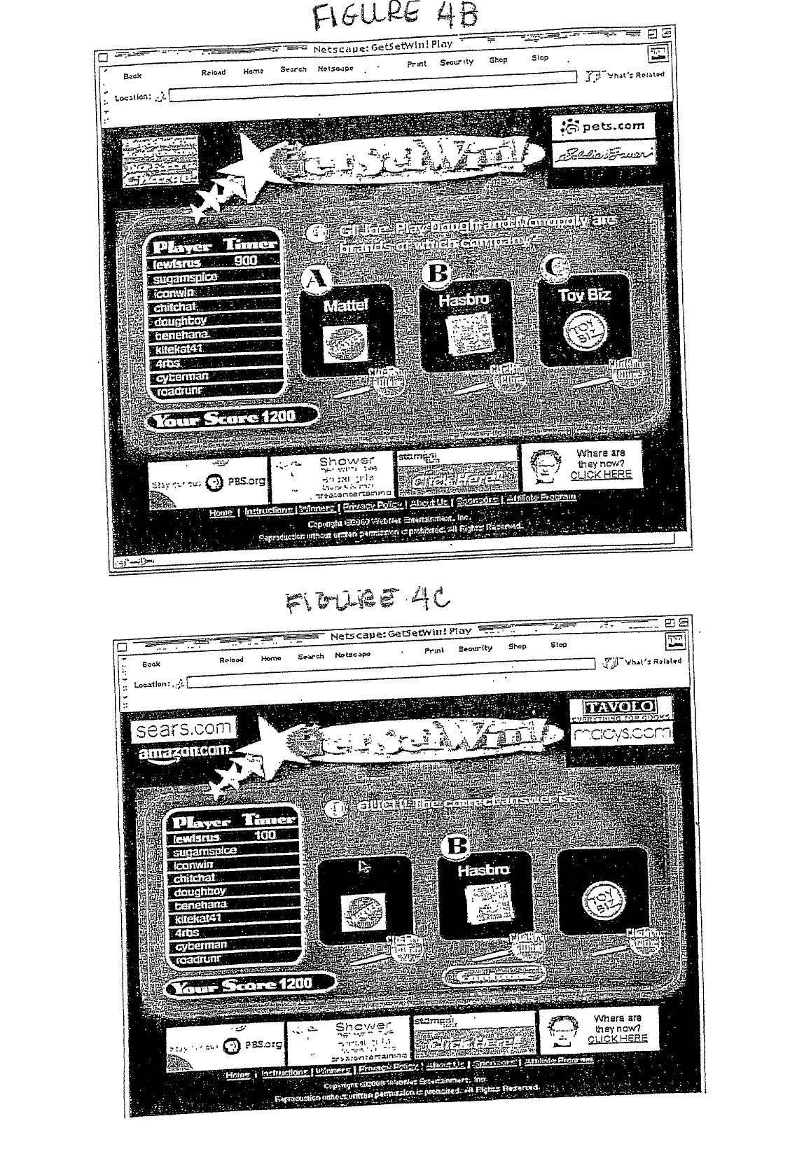

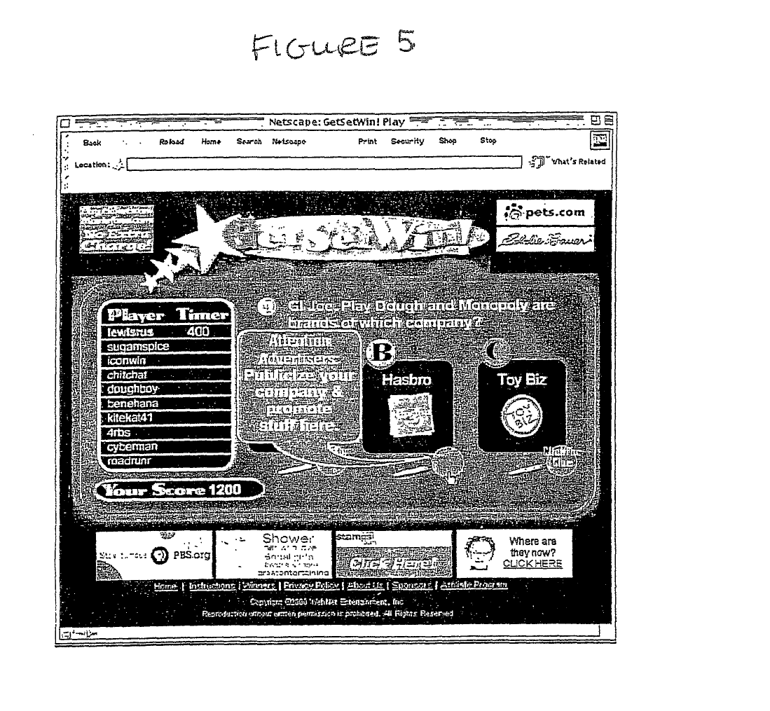

FIGS. 4A-C are illustrative screens depicting trivia game questions and answers. FIG. 4A depicts a screen showing selection of a correct answer. Choice B is selected and the term “right” is displayed above the selections. FIGS. 4B and 4C depict screen displays of another trivia question and an incorrect answer, respectively. In FIG. 4B the player is asked to identify the company corresponding to a list of brand names. FIG. 4C is a screen display indicating that an incorrect answer was chosen, and displaying the correct answer.

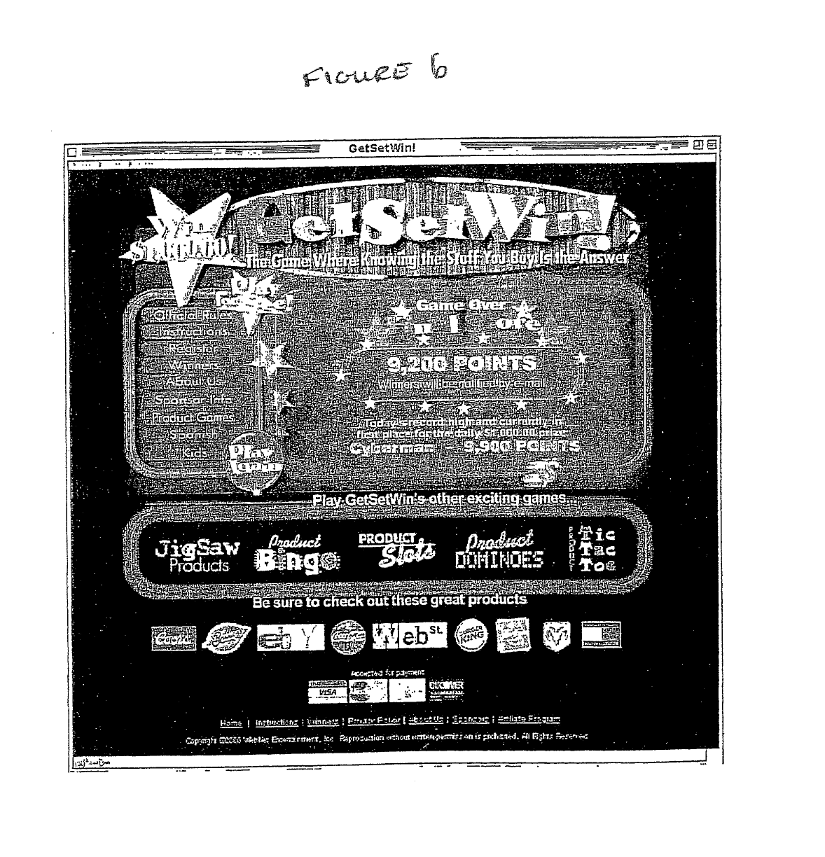

FIG. 5 is a screen display showing a clue accessed by a player clicking on the magnifying glass image. The clue provides promotional information. Advertisers immediately benefit when a player accesses a clue, because additional marketing information is displayed which the player reads to progress in the game. Clues may reinforce important concepts, messages, jingles and logos. Advertisers may announce specials, discounts, and coupons in these pop-up windows. The instantaneous clue feature may maximize an advertiser's messages.

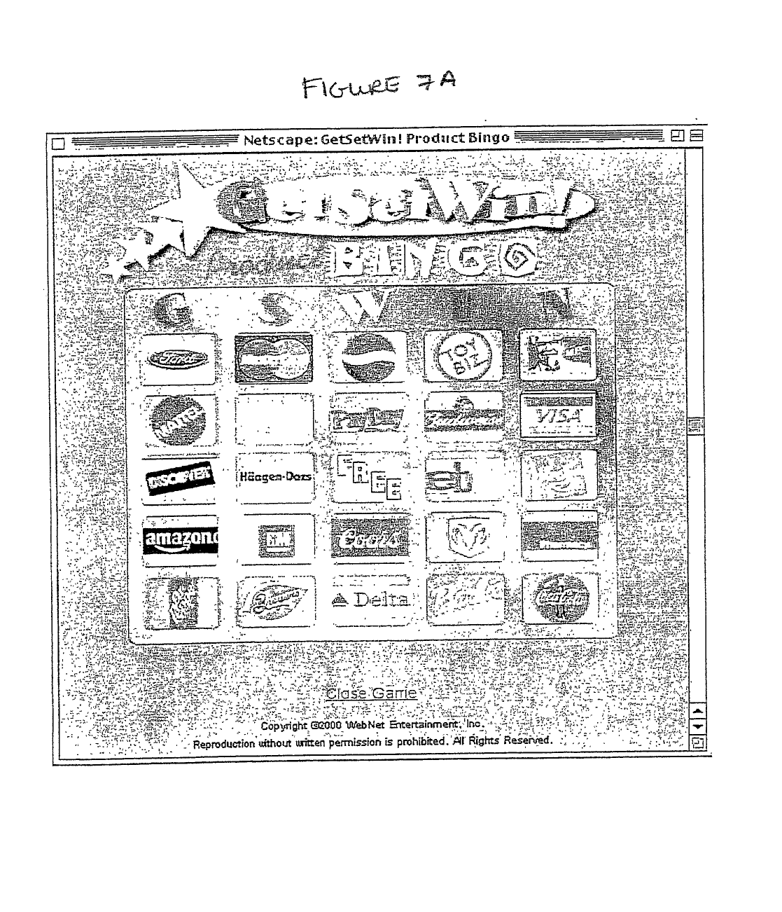

FIG. 6 depicts a screen display of a “game over” page. In this illustrative screen shot, final scores are displayed with the current record high score of the day. Advertising images are also displayed on this page to provide additional exposure. The images may provide links to advertisers' websites or other information, such as a return to questions posed regarding those advertisers. A “play again” option is also provided in this illustrative embodiment. It is possible for the player to play the same type of game again or select from additional game types.

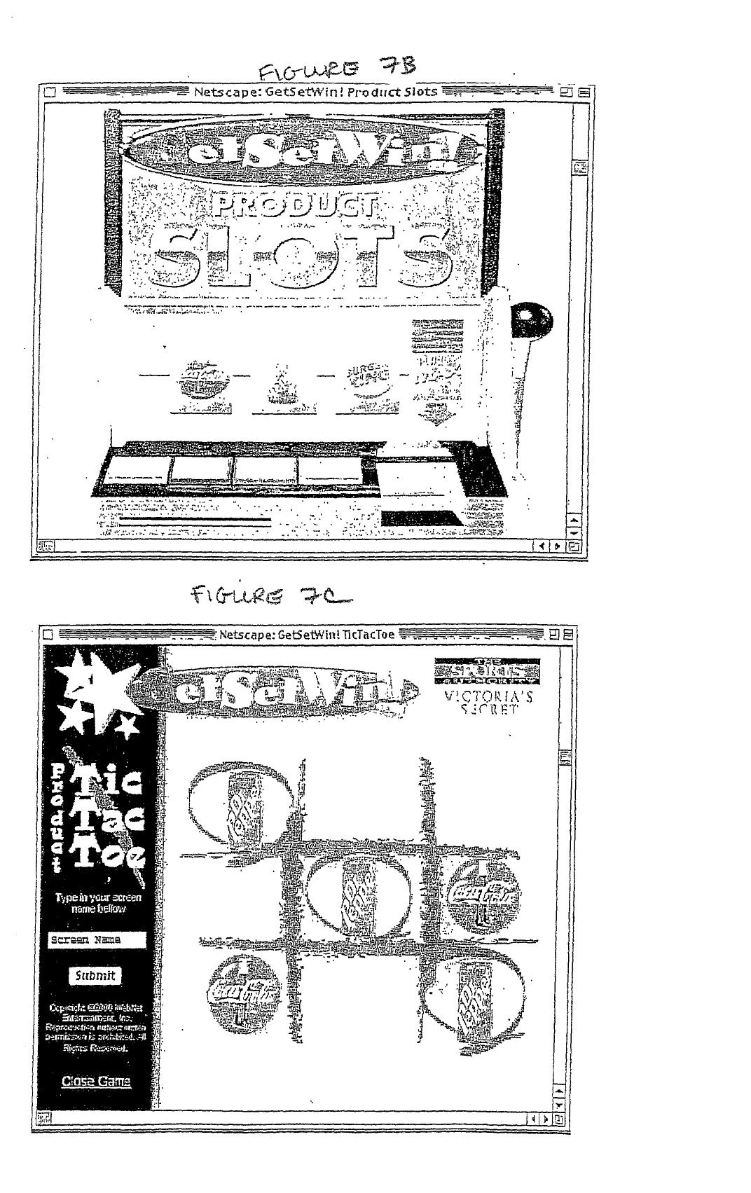

FIGS. 7A-E depict screen shots of additional games according to illustrative embodiments of the invention. FIGS. 7A-E depict bingo, slots, tic-tac-toe, dominoes and a jigsaw puzzle, respectively.

As seen in FIG. 7C, advertisements may be displayed in addition to the images actually incorporated into the game. FIG. 7C shows Coke® and Dr. Pepper® as tic-tac-toe game pieces. The Sports Authority and Victoria's Secret, however, are advertised on the screen, but are not incorporated into the game. Embodiments of the invention may incorporate the use of traditional banner ads and click-through links to advertisers.

Embodiments of the present invention include the ability to license rights to advertisers to feature their merchandise, services, company names, logos and other promotional information, in a database of a computer system. Questions may be prepared by advertisers themselves. This allows advertisers to customize questions to meet their company needs while insuring content accuracy. Preferably, the interactive game is placed into a computer advertising spot as opposed to a game site.

Embodiments of the present invention include a template for an interactive game that can be re-used to incorporate different advertising images and promotional material. The templates are likely to reduce the cost of producing the games. In an illustrative embodiment, the template includes an interactive game format, one or more advertising image fields and one or more advertising material fields. The template may contain additional fields into which player information may be input. Player information may be matched with advertising images and material via audience targeting programming to further customize the game.

In an exemplary embodiment of the invention, an advertiser, licensor, or other user inputs advertising images and advertising material into template fields. When a player accesses the game, the player enters information, such as age, interests and residence, into additional fields. The audience targeting programming then matches one or more advertising images and material to the player information to customize the game for use by the particular player.

In a further embodiment of the invention, the template includes one or more prize information fields into which information regarding prizes available to players may be entered.

The interactive nature of the games, and the ability of advertisers to provide information to a captive audience creates an effective marketing and sales mechanism. Players interact in a positive, pro-active manner with the products, services and icons they see. Sponsors may get worldwide exposure if used on the Internet. Provisions may also be made within the game for consumers to buy products they see.

The invention further comprises a computer data signal embodied in a transmission medium to execute an advertising game on a computer network. The executed advertising game is as described above.

While the invention has been described by illustrative embodiments, additional advantages and modifications will occur to those skilled in the art. Therefore, the invention in its broader aspects is not limited to specific details shown and described herein. Modifications, for example, to the type of game, screen format and game details, may be made without departing from the spirit and scope of the invention. It will also be appreciated that a system in accordance with the invention can be constructed in whole or in part from special purpose hardware or from conventional general purpose hardware or any combination thereof, any portion of which may be controlled by a suitable program. Any program may in whole or in part be comprised of or be stored on a system in a conventional manner, or remain whole or in part be provided into the system over a network or other mechanism for transferring information in a conventional manner. Accordingly, it is intended that the invention not be limited to the specific illustrative embodiments but be interpreted within the full spirit and scope of the appended claims and their equivalents.

1. A method of advertising on a computer network comprising:
incorporating one or more advertising images into an interactive game;
presenting the interactive game to one or more players via the computer network;
prompting the one or more players to access advertising material associated with the one or more advertising images to play the interactive game; and
wherein the advertising material is accessible independent of accessing an advertiser's website.

2. The method of claim 1 wherein at least one advertising image is an active element of the game.

3. The method of claim 1 wherein the game is a trivia game and the associated advertising material provides clues to answer trivia questions.

4. The method of claim 1 further comprising prompting the one or more players to access advertising material from an advertiser's website to progress in the interactive game.

5. The method of claim 1 further comprising providing one or more prizes to one or more winning players.

6. The method of claim 1 further comprising:
compiling information on the one or more players; and
tailoring advertising content of the interactive game to the one or more players.

7. The method of claim 1 wherein the game is selected from the group consisting of: trivia games, bingo, dominoes, casino games, card games, tic-tac-toe and jigsaw puzzles.

8. A method in a computer system for accommodating advertising content in an interactive game comprising:
providing an advertiser a right to feature advertising content in an interactive game accessible on a computer network wherein:
one or more advertising images are incorporated into the game;
one or more players access advertising material associated with the one or more advertising images to play the game; and
the advertising material is accessible independent of accessing the advertiser's website.

9. The method of claim 8 wherein at least one advertising image is an active element of the game.

10. The method of claim 8 wherein the interactive game is a trivia game and the associated advertising material provides clues to answer trivia questions.

11. The method of claim 8 further comprising prompting the one or more players to access advertising material from an advertiser's website to progress in the interactive game.

12. The method of claim 8 further comprising providing one or more prizes to one or more winning players.

13. The method of claim 8 wherein the game is contained on a template, the template having a plurality of fields, the method further comprising:
entering the one or more advertising images into one or more fields in the template; and
entering the advertising material into one or more fields in the template.

14. The method of claim 13 further comprising:
prompting a player to input player information; and
selecting one or more advertising images and advertising material based on the player information.

15. The method of claim 8 further comprising:
compiling information on the one or more players; and
tailoring advertising content of the interactive game to the one or more players.

16. The method of claim 8 wherein the game is selected from the group consisting of: trivia games, bingo, dominoes, casino games, card games, tic-tac-toe and jigsaw puzzles.

17. The method of claim 8 further comprising:
placing the interactive game into a computer advertising spot.

18. In a computer system, an advertising game played by one or more players comprising:
one or more advertising images;
one or more prompts for the one or more players to access advertising material associated with the one or more advertising images to play the interactive game; and
wherein the advertising material is accessible independent of accessing an advertiser's website.

19. The advertising game of claim 18 wherein at least one advertising image is an active element of the game.

20. The advertising game of claim 18 wherein the game is a trivia game and the associated advertising material provides clues to answer trivia questions.

21. The advertising game of claim 18 further comprising prompting the one or more players to access advertising material from an advertiser's website to progress in the interactive game.

22. The advertising game of claim 18 further comprising providing one or more prizes to one or more winning players.

23. The advertising game of claim 18 further comprising:
compiling information on the one or more players; and
tailoring advertising content of the interactive game to the one or more players.

24. The advertising game of claim 18 wherein the game is selected from the group consisting of: trivia games, bingo, dominoes, casino games, card games, tic-tac-toe and jigsaw puzzles.

25. A computer data signal embodied in a transmission medium to execute an advertising game on a computer network, wherein the computer data signal comprises one or more code segments comprising:
one or more advertising images;
one or more prompts for the one or more players to access additional advertising material to play the interactive game; and
wherein the advertising material is executed by the data signal independent of accessing an advertiser's website.

26. The computer data signal of claim 25 wherein at least one advertising image is an active element of the game.

27. The computer data signal of claim 26 wherein the game is a trivia game and the associated advertising material provides clues to answer trivia questions.

28. The computer data signal of claim 27 further comprising prompting the one or more players to access advertising material from an advertiser's website to progress in the interactive game.

29. The computer data signal of claim 28 further comprising providing one or more prizes to one or more winning players.

30. The computer data signal of claim 29 further comprising:
compiling information on the one or more players; and
tailoring advertising content of the interactive game to the one or more players.

31. The computer data signal of claim 30 wherein the game is selected from the group consisting of: trivia games, bingo, dominoes, casino games, card games, tic-tac-toe and jigsaw puzzles.

32. A template for an interactive game, the game used for advertising in a computer system, the template comprising:
an interactive game format;
one or more advertising image fields; and
one or more advertising material fields.

33. The template of claim 32 wherein the game is selected from the group consisting of trivia games, bingo, dominoes, casino games, card games, tic-tac-toe and jigsaw puzzles.

34. The template of claim 32 wherein the interactive game is a trivia game and the advertising material provides clues to answer trivia questions.

35. The template of claim 32 further comprising one or more prize information fields.

36. The template of claim 32 further comprising:
player information fields; and
audience targeting programming to customize the interactive game based on player information;
wherein the audience targeting programming matches player information to advertising images and advertising material to be incorporated into the interactive game.
